(19) United States
(12) Patent Application Publication
(10) Pub. No.: US 2025/0299515 A1
(43) Pub. Date: Sep. 25, 2025

(54) WALKING PHASE DETERMINATION SUPPORT SYSTEM

(71) Applicants: TOYODA GOSEI CO., LTD., Kiyosu-shi (JP); NATIONAL UNIVERSITY CORPORATION TOKAI NATIONAL HIGHER EDUCATION AND RESEARCH SYSTEM, Nagoya-shi (JP)

(72) Inventors: Takeshi FUJIWARA, Aichi (JP); Tsuyoshi IKEFUJI, Aichi (JP); Hitoshi HIRATA, Aichi (JP); Shingo SHIMODA, Aichi (JP); Hidemasa YONEDA, Aichi (JP); Takashi YAMAGA, Aichi (JP)

(21) Appl. No.: 19/085,571

(22) Filed: Mar. 20, 2025

(30) Foreign Application Priority Data
Mar. 22, 2024 (JP) 2024-046906

(51) Int. Cl. G06V 40/20; G06F 3/14; G06T 5/50; G06T 7/194; G06V 20/52

(52) U.S. Cl. CPC G06V 40/25; G06F 3/14; G06T 5/50; G06T 7/194; G06V 20/52; G06T 2207/20044; G06T 2207/20221

(57) ABSTRACT

A walking phase determination support system includes an imaging unit configured to image a walking motion of a pedestrian; a detection unit configured to detect a change over time in a force applied to each part of a sole of the pedestrian in synchronization with imaging; an input unit configured to be operated to designate a walking-phase-to-be-determined; a display unit configured to display a video; and a control unit configured to display a moving image captured and, as display still images, still images captured at different timings from among still images forming the moving image. The control unit is configured to estimate, based on a change over time in a detection value, as a specific timing, a timing at which the walking phase becomes the walking-phase-to-be-determined, and is configured to display one display still image corresponding to the specific timing in a form associated with the walking-phase-to-be-determined.

### CROSS-REFERENCE TO RELATED APPLICATIONS

This application is based on and claims priority under 35 USC 119 from Japanese Patent Application No. 2024-46906 filed on Mar. 22, 2024, the entire content of which is incorporated herein by reference.

### TECHNICAL FIELD

The present disclosure relates to a walking phase determination support system that supports determination of a walking phase performed by observing a walking motion of a pedestrian.

### BACKGROUND ART

A physical therapist, an orthopedic surgeon, or the like supports a person who has a physical disability due to injury, illness, or the like or a person who is predicted to develop a physical disability (hereinafter, such a person is referred to as a patient) by providing them with exercise therapy, physical therapy, or the like to help them live independent daily lives. When providing this support, the physical therapist or the like generally performs walking analysis on a patient. In the walking analysis, it is required to accurately determine which walking phase of a walking cycle the patient is in by observing a walking motion thereof. The walking cycle is, for example, a period from when the heel of one of the left and right feet comes into contact with the ground to when the heel comes into contact with the ground again in the walking motion. The walking cycle includes a stance phase including a plurality of walking phases, and a swing phase including a plurality of walking phases. Each walking phase has a role to be fulfilled. When a state deviating from a normal state is observed in any of the walking phases, there is room for improvement in a walking posture in the walking phase and walking phases before and after. It is necessary for the patient to take measures to return to a normal state. Therefore, it is important to accurately determine the walking phase.

In the related art, a determining person such as a physical therapist or an orthopedic surgeon makes a patient walk as a pedestrian. By visually observing a walking motion of the pedestrian, a walking phase is determined based on subjective judgment such as experience.

As a related technique, JP2020-185064A describes a technique of acquiring walking cycle data from walking-related data relating to walking using a walker, and calculating a stride length of a pedestrian based on both pieces of data. Examples of the walking-related data include walking distance data, walking speed data, heart rate data, and arm swing time data.

### SUMMARY OF INVENTION

In determining the walking phase simply by observing the walking motion, it is difficult for an inexperienced physical therapist or the like to accurately determine the walking phase. Therefore, there is a demand for a technique to support the determination so that the walking phase can be accurately determined regardless of experience.

In the technique described in JP2020-185064A the walking cycle data is used, but is not a technique that supports determination of a walking phase performed by observing a walking motion, and thus it is difficult to meet the above demand.

Aspects of a walking phase determination support system to address the above will be described as follows.

(1) A walking phase determination support system that supports determination of a walking phase performed by observing a walking motion of a pedestrian, the walking phase determination support system comprising:
an imaging unit configured to image the walking motion of the pedestrian;
a detection unit configured to detect a change over time in a force applied to each of a plurality of parts of a sole of the pedestrian in synchronization with imaging by the imaging unit;
an input unit configured to be operated to designate a walking phase to be determined that is a target of the determination among a walking cycle including a plurality of types of the walking phase;
a display unit configured to display a video related to the walking motion of the pedestrian; and
a control unit configured to display, on the display unit, a moving image captured by the imaging unit, and display, on the display unit as display still images, a plurality of still images captured at a plurality of different timings from among still images forming the moving image,
in which the control unit is configured to estimate, based on a change over time in a detection value of the detection unit, as a specific timing, a timing at which the walking phase of the pedestrian becomes the walking phase to be determined that is designated by an operation on the input unit, and is configured to display, on the display unit, one display still image corresponding to the specific timing among the plurality of display still images in a form associated with the walking phase to be determined.

According to the above configuration, the walking motion of the pedestrian is captured by the imaging unit. A change over time in the force applied to each of the plurality of parts of the sole of the pedestrian is detected by the detection unit in synchronization with the imaging. The determining person operates the input unit to designate a walking phase to be determined that is a target of the determination.

The moving image captured by the imaging unit is displayed on the display unit by the control unit. In addition, the control unit displays, among the still images included in the moving image, a plurality of still images captured at a plurality of different timings on the display unit as the display still images. By viewing the display unit, the determining person may determine the walking phase by selecting one display still image that is considered to correspond to the walking phase to be determined, which is the target of the determination, from among the plurality of display still images on display.

Here, the change over time in the detection value of the detection unit is closely related to the walking phase. The change over time in the detection value is represented as, for example, a pressure waveform. The pressure waveform is a waveform in which a section where the value is substantially constant and a section where the value changes are periodically repeated. The former section is a section in which a foot is away from the ground, and the latter section is a section in which a foot is in contact with the ground. For example, the force applied to the heel increases as the heel touches the ground. This force changes as a ground contact portion of the sole of the foot moves from the heel toward the toe. The force is minimized when the heel leaves the ground or when the heel is away from the ground. The force applied to the toe also changes in the same manner.

Therefore, the control unit estimates, based on the change over time in the detection

value of the detection unit, the timing when the walking phase of the pedestrian is the walking phase to be determined as the specific timing. Then, among the plurality of display still images, the display still image corresponding to the specific timing is displayed on the display unit in a form associated with the walking phase to be determined. Among the plurality of display still images displayed on the display unit, the display still image corresponding to the specific timing is displayed in a form different from the other display still images.

Therefore, by viewing the display unit, the determining person may determine which display still image among the plurality of display still images on display corresponds to the designated walking phase to be determined. In addition, by comparing the display still image corresponding to the walking phase to be determined with the display still image determined (selected) by the determining person, it is possible to determine whether the determination of the determining person for the walking phase is correct.

(2) The walking phase determination support system according to (1),
in which the control unit is configured to remove a background image from the still images and display, on the display unit as the display still images, the still images after the background image is removed.

According to the above configuration, the control unit removes the background image not involved in the determination of the walking phase from the still image. The remaining image of the pedestrian is displayed on the display unit as the display still image. Therefore, compared to a case where a display still image including the background is displayed on the display unit, the pedestrian is easily observed, and the walking phase is easily determined.

(3) The walking phase determination support system according to (1) or (2),
in which the control unit is configured to estimate a feature related to the walking motion of the pedestrian based on a detection value of the detection unit, determine whether the walking motion at the specific timing is abnormal walking based on the feature, and display the display still image corresponding to the specific timing on the display unit in a form associated with a result of the determination related to the abnormal walking.

According to the above configuration, the control unit estimates the feature related to

the walking motion of the pedestrian based on the detection value of the detection unit. Based on the feature, it is determined whether the walking motion at the specific timing is abnormal walking. The display still image corresponding to the specific timing is displayed on the display unit in a state of being associated with a result of the determination as to whether the walking motion is abnormal walking. Therefore, the determining person may know whether the walking at the specific timing is abnormal walking by viewing the display unit.

(4) The walking phase determination support system according to any one of (1) to (3), in which the control unit is configured to estimate data of a skeleton of the pedestrian based on at least the display still image corresponding to the specific timing, and display an image corresponding to the data of the skeleton and resembling the skeleton on the display unit in a state of being superimposed on an image of the pedestrian in the display still image corresponding to the specific timing.

According to the above configuration, the control unit estimates the data of the skeleton of the pedestrian based on at least the display still image corresponding to the specific timing. That is, a plurality of body parts of the pedestrian are recognized, and data on the skeleton of the pedestrian is estimated from the position relationship between the body parts. An image corresponding to the estimated data of the skeleton and resembling the skeleton is displayed on the display unit in a state of being superimposed on the image of the pedestrian in the display still image corresponding to the specific timing.

Therefore, by viewing the display unit, the determining person may determine the state of the skeleton of the pedestrian when the walking phase is at least the walking phase to be determined, for example, a degree of a joint angle.

According to aspects of the present disclosure, it is possible to improve determination accuracy by supporting determination of a walking phase by a determining person.

### BRIEF DESCRIPTION OF DRAWINGS

Exemplary embodiment(s) of the present invention will be described in detail based on the following figures, wherein:

FIG. 1 is a diagram of a display unit displaying a display still image in which an image resembling a skeleton is superimposed on an image of a pedestrian in one embodiment;

FIG. 2 is a block diagram showing a configuration of a walking phase determination support system according to the embodiment;

FIG. 3 is a diagram illustrating a part of the configuration of the walking phase determination support system in the embodiment;

FIG. 4 is a diagram illustrating an arrangement state of pressure sensors in an insole and a position relationship with each part of a sole in the embodiment;

FIG. 5 is a diagram illustrating a relationship between a walking posture that changes as a pedestrian walks and each walking phase in a walking cycle in the embodiment;

FIG. 6 is a flowchart showing a process performed by a control unit when supporting determination of a walking phase in the embodiment;

FIG. 7 is a characteristic diagram showing a pressure waveform created based on detection values of the pressure sensors in the embodiment;

FIG. 8 is a characteristic diagram showing an actual pressure waveform of pressure applied to the sole of a left foot in the embodiment;

FIG. 9 is a characteristic diagram showing an actual pressure waveform of pressure applied to the sole of a right foot in the embodiment;

FIG. 10 is a diagram illustrating lines of force estimated based on detection values of the pressure sensors in the embodiment;

FIG. 11 is a characteristic diagram of lines of force estimated for the left foot based on detection values of the pressure sensors in the embodiment;

FIG. 12 is a characteristic diagram of lines of force estimated for the right foot based on detection values of the pressure sensors in the embodiment; and

FIG. 13 is a diagram of a display unit according to a modification in which a display still image of a pedestrian is displayed without an image resembling a skeleton being superimposed thereon.

### DESCRIPTION OF EMBODIMENTS

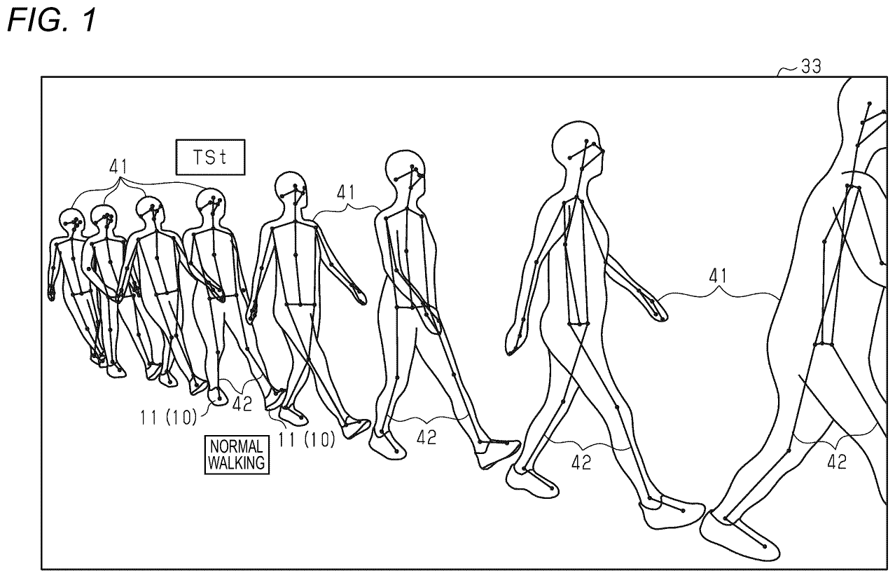

Hereinafter, a walking phase determination support system according to an embodiment will be described with reference to FIGS. 1 to 12.

The walking phase determination support system is a system for supporting determination of a walking phase performed by observing a walking motion of a pedestrian P1. The pedestrian P1 may be, for example, a patient undergoing orthopedic treatment or rehabilitation of motor function.

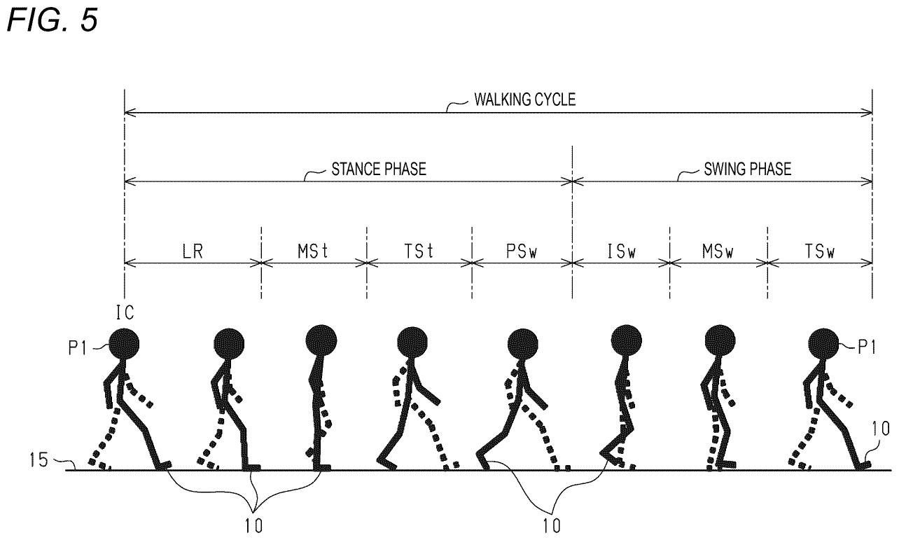

FIG. 5 shows a relationship between walking motions of the pedestrian P1 and a walking cycle including a plurality of types of walking phases. The walking cycle is a period from when one foot 10 touches a walking path 15, swings out, and touches the walking path 15 again. The walking cycle includes a stance phase in which the sole of the foot steps on the walking path 15 and supports the body, and a swing phase in which the one foot 10 is lifted and swung forward.

The stance phase includes a plurality of walking phases such as an initial contact phase IC, a load response phase LR, a middle stance phase MSt, a terminal stance phase TSt, and a pre-swing phase PSw. The swing phase includes a plurality of walking phases such as an initial swing phase ISw, a middle swing phase MSw, and a terminal swing phase TSw. Each walking phase is defined as follows. In FIG. 5, the one foot 10 (right foot) of the pedestrian P1 is represented by a thick solid line, and a contralateral lower leg (left lower leg, no reference numeral) is represented by a thick broken line.

Initial contact phase IC: the moment when the one foot 10 touches the walking path 15.

Load response phase LR: a period from the moment when the one foot 10 touches the walking path until the contralateral lower leg leaves the walking path 15.

Middle stance phase MSt: a period from when the contralateral lower leg leaves the walking path 15 until when the heel of the contralateral lower leg leaves the walking path 15. In the middle stance phase MSt, only the one foot 10 is in contact with the walking path.

Terminal stance phase TSt: a period from when the heel of the contralateral lower leg leaves the walking path 15 until when the contralateral lower leg touches the walking path. The contralateral lower leg reaches the initial contact phase IC at the end of the terminal stance phase TSt.

Pre-swing phase PSw: a period from when the contralateral lower leg touches the walking path until when the toes of the one foot 10 leaves the walking path 15.

Initial swing phase ISw: a period from when the toes of the one foot 10 leaves the walking path 15 until when both lower legs cross.

Middle swing phase MSw: a period from when both lower legs cross until when the lower leg becomes vertical.

Terminal swing phase TSw: a period from when the lower leg becomes vertical until when the one foot 10 touches the walking path.

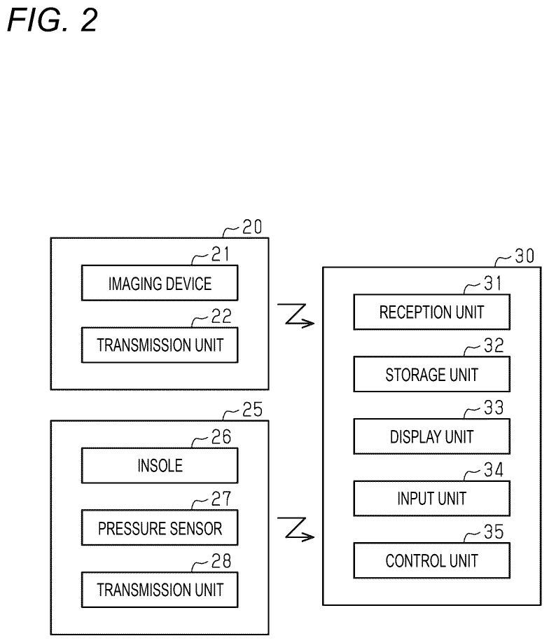

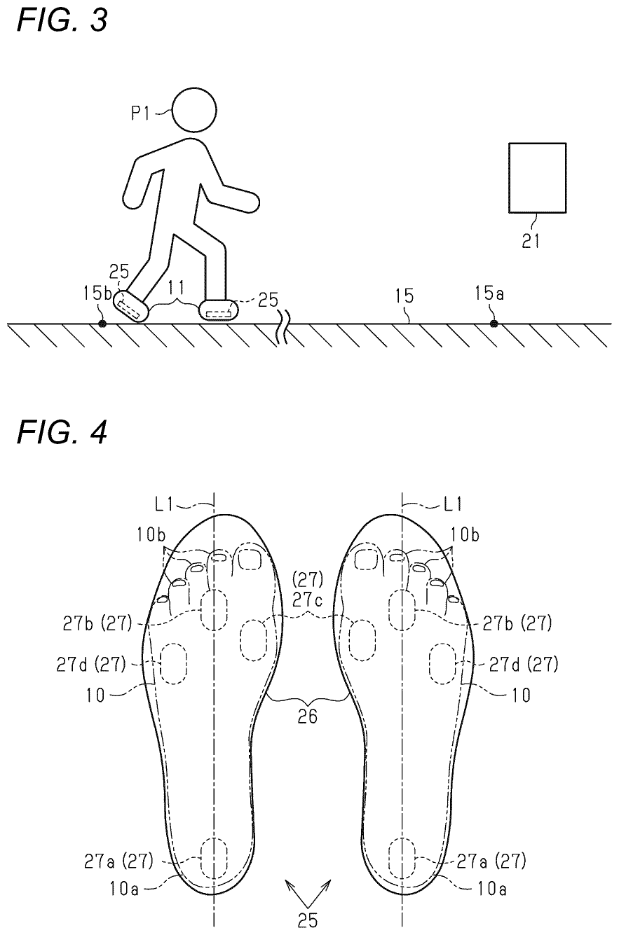

As shown in FIGS. 2 and 3, the walking phase determination support system includes an imaging unit 20, a detection unit 25, and a determination support device 30. Next, each part of the walking phase determination support system will be described.

### Imaging Unit 20

The imaging unit 20 is for imaging a walking motion of the pedestrian P1. The imaging unit 20 is installed on the walking path 15 that is horizontal or nearly horizontal. The walking path 15 may be provided indoors or outdoors.

The imaging unit 20 includes at least one imaging device 21. Examples of the imaging device 21 include a digital camera, a tablet equipped with a digital camera, or the like. In the present embodiment, the imaging device 21 is disposed near one end portion 15a of the walking path 15, offset outward in a width direction of the walking path 15, and facing the other end portion 15b of the walking path 15.

Assuming that a direction from the end portion 15b toward the end portion 15a is a forward direction, the imaging device 21 generates an image by imaging the pedestrian P1 walking on the walking path 15 from an obliquely forward direction. The imaging device 21 generates imaging data of a moving image in which the plurality of images are consecutive over time.

The imaging unit 20 includes a transmission unit 22 in addition to the imaging device 21. The transmission unit 22 transmits the imaging data of the moving image generated by the imaging device 21 to a reception unit 31 of the determination support device 30.

### Detection Unit 25

As shown in FIGS. 2 to 4, the detection unit 25 is for detecting a change over time in a force applied to each of the plurality of parts of the sole of the pedestrian P1 in synchronization with the imaging by the imaging unit 20. The detection unit 25 is provided in each of the left and right shoes 11. Each detection unit 25 includes an insole (shoe insert) 26 placed on the inside bottom of the shoe 11, and a pressure sensor 27 and a transmission unit 28 incorporated in the insole 26. The pressure sensor 27 detects pressure as a force applied to each of a plurality of parts of the sole of the foot 10 during walking. The pressure sensor 27 includes a heel sensor 27a, a toe sensor 27b, an inner sensor 27c, and an outer sensor 27d.

The heel sensor 27a is disposed in the insole 26 at a portion of the heel 10a to which a load is applied, and detects the pressure applied to the heel 10a of the sole. The toe sensor 27b is disposed in the insole 26 at any one of portions to which a load is applied among five toes forming the toe 10b, and detects the pressure applied to the toe 10b of the sole.

Here, the inner side of the foot 10 is the side close to the opposite foot 10 in a left-right direction, and the outer side is the side farther from the opposite foot 10 in the left-right direction.

The inner sensor 27c is disposed in the insole 26 on the inner side of an imaginary line L1 connecting the heel sensor 27a and the toe sensor 27b and at a portion to which a load of the ball of the foot is applied, and detects the pressure applied to an inner portion of the sole. The outer sensor 27d is disposed in the insole 26 on the outer side of the imaginary line L1 and at a portion to which a load of the ball of the little toe is applied, and detects the pressure applied to an outer portion of the sole.

When it is not necessary to distinguish the heel sensor 27a, the toe sensor 27b, the inner sensor 27c, and the outer sensor 27d from each other, they may be simply referred to as “pressure sensors 27”.

Each pressure sensor 27 independently detects the pressure applied to each part of the sole at every predetermined time.

The reason why the pressure sensors 27 are disposed at the four locations in the insole 26 is as follows.

During walking, among the plurality of parts of the sole, the heel 10a lands first, and a landing portion changes in sequence from the heel 10a to the toe 10b. After the heel 10a lands and before the toe 10b lands, at least one of the parts on the inner side and the parts on the outer side of the imaginary line L1 lands. A generated toe gripping force varies depending on the landing portion.

Therefore, in the present embodiment, the pressure sensors 27 (the heel sensor 27a, the toe sensor 27b) are incorporated in the insole 26 at the portion of the heel 10a to which the load is applied and the portion of the toe 10b to which the load is applied. The pressure sensors 27 (the inner sensor 27c and the outer sensor 27d) are incorporated in the insole 26 at the portions on the inner side and the outer side with respect to the imaginary line L1. Therefore, the pressure sensors 27 incorporated in the insole 26 appropriately detect the change over time in pressure applied to each of the plurality of parts of the sole.

The pressure sensor 27 may be a known pressure-sensitive sensor using a piezoelectric element or the like. In particular, considering that the sensor will be placed on the sole, it is preferable to use a capacitance-type sensor made of an elastomer that utilizes a dielectric elastomer, from the viewpoint of elasticity and durability. Examples of the dielectric elastomer include crosslinked polyrotaxane, silicone elastomer, acrylic elastomer, and urethane elastomer.

The above-mentioned capacitance-type sensor made of an elastomer may be formed thin overall, so that even if it is placed inside the insole 26, a thickness of the insole 26 does not increase significantly. This sensor has a structure in which a dielectric elastomer is disposed between a pair of electrodes. When the dielectric elastomer is deformed by tension or stress, the amount of electricity (capacitance) stored in the electrode changes. An amount of this change is detected as the pressure on the sole.

A detection value detected by each pressure sensor 27 may be converted into a pressure value corresponding to a detection method of the pressure sensor 27, such as a capacitance value or an electrical resistance value. Therefore, the “detection value” described below may be read as the detection value of the pressure at the position where the pressure sensor 27 is attached on the sole.

The transmission unit 28 transmits the detection value of each pressure sensor 27 to the reception unit 31 of the determination support device 30.

### Determination Support Device 30

As shown in FIG. 2, the determination support device 30 includes, for example, a computer such as a mobile terminal or a tablet terminal.

The determination support device 30 includes the reception unit 31 that receives the imaging data transmitted from the transmission unit 22 of the imaging unit 20 and the detection value transmitted from the transmission unit 28 of the detection unit 25, and a storage unit 32 that stores the received imaging data and detection value. The reception unit 31 includes a wired or wireless communication unit, and communicates with the transmission unit 22, 28 by a known communication method.

Examples of the storage unit 32 include an HDD, an SSD, and a semiconductor memory element. The storage unit 32 may be a storage device connected to the determination support device 30 via a network.

The determination support device 30 further includes a display unit 33, an input unit 34, and a control unit 35.

Various images are displayed on the display unit 33. The image displayed on the display unit 33 includes a video of the walking motion of the pedestrian P1. As the display unit 33, for example, a known display device such as a liquid crystal display may be used.

The input unit 34 is operated when inputting various types of information. For example, the input unit 34 is operated to designate a walking phase to be determined, which is a target of the determination, among the walking cycle including a plurality of types of walking phases. As the input unit 34, for example, a known input device such as a keyboard, a mouse, or a touch panel may be used.

The control unit 35 performs a walking phase determination support process based on the imaging data, the detection value, and the like stored in the storage unit 32.

### Operations of Present Embodiment

Next, a procedure for supporting walking phase determination in the walking phase determination support system according to the present embodiment configured as described above will be described.

As shown in FIGS. 2 to 4, the pedestrian P1 wears the shoe 11 with the insoles 26 placed therein. The pedestrian P1 walks along the walking path 15 from the other end portion 15b toward the one end portion 15a.

The imaging device 21 generates images by imaging the walking motion of the pedestrian P1 while the pedestrian is walking along the walking path 15. The imaging device 21 generates imaging data of a moving image in which the plurality of images are consecutive over time. The imaging device 21 transmits the generated imaging data from the transmission unit 22 of the imaging unit 20 to the reception unit 31 of the determination support device 30.

Further, during a period in which the pedestrian P1 is walking along the walking path 15, the pressure sensor 27 detects a change over time in the pressure applied to each of the plurality of parts of the sole in synchronization with the imaging described above. That is, the heel sensor 27a detects the pressure applied to the heel 10a of the sole, and the toe sensor 27b detects the pressure applied to the toe 10b of the sole. The inner sensor 27c detects the pressure applied to the inner portion of the sole, and the outer sensor 27d detects the pressure applied to the outer portion of the sole. The transmission unit 28 of the detection unit 25 transmits the detection value to the reception unit 31 of the determination support device 30.

The reception unit 31 of the determination support device 30 receives the imaging data transmitted from the transmission unit 22 of the imaging unit 20 and stores the imaging data in the storage unit 32. The reception unit 31 receives the detection value transmitted from the transmission unit 28 of the detection unit 25 and stores the detection value in the storage unit 32.

A determining person who tries to determine a predetermined walking phase by observing the walking motion of the pedestrian P1 operates the input unit 34 to designate a walking phase to be determined, which is a target of the determination. The determining person is typically a physical therapist, an orthopedic surgeon, or the like, but may also be the pedestrian P1. As a timing for the determining person to perform an input operation on the input unit 34, for example, after the determining person observes a plurality of display still images 41 displayed on the display unit 33 and selects the one that corresponds to the walking phase that is supposed to be determined (walking phase to be determined).

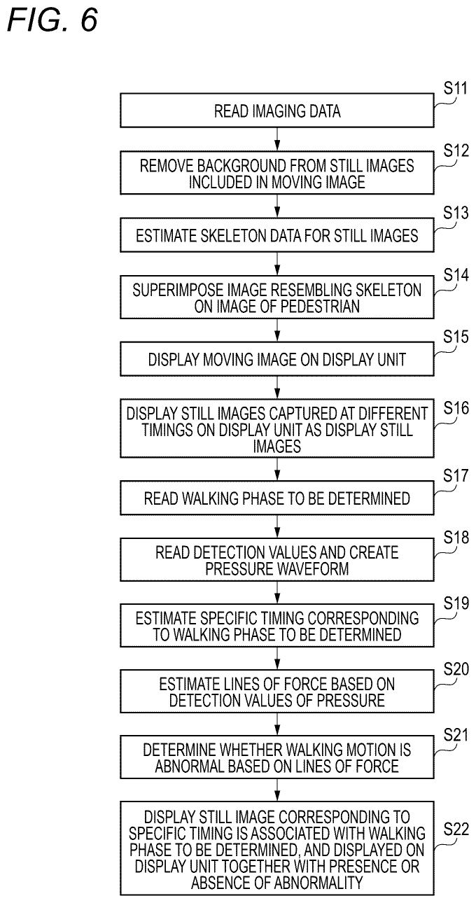

The flowchart of FIG. 6 shows a process performed by the control unit 35 when supporting determination of a walking phase.

In step S11, imaging data of the moving image captured by the imaging unit 20 and stored in the storage unit 32 is read.

In step S12, a background image that is not involved in the determination of the walking phase is removed from the still images included in the moving image.

In step S13, for the still images, skeleton data of the pedestrian P1 is estimated by using a technique called skeleton estimation. The skeleton estimation is a technique of recognizing positions of a plurality of parts of a human body such as joints and parts (eyes, nose, ears, and the like) constituting a face, and estimating a skeleton of the human body from a position relationship between the parts.

In step S14, an image 42 corresponding to the estimated skeleton data and resembling the skeleton, for example, an image 42 including a plurality of dots (·) and a plurality of straight lines connecting adjacent dots is superimposed on the image of the pedestrian P1. The dots represent joints, and the straight lines are also called skeleton lines, represent the skeleton.

In step S15, as described above, a moving image including a plurality of still images, each of which has the background image removed and the image 42 resembling a skeleton superimposed on the image of the pedestrian P1, is displayed on the display unit 33.

In step S16, as shown in FIG. 1, among the still images included in the moving image, a plurality of still images captured at a plurality of different timings are displayed on the display unit 33 as the display still images 41. The plurality of timings may be, for example, timings at regular time intervals, but are not limited thereto. As described above, a method of freezing one of the still images included in the moving image as if time is stopped, leaving it in a still image state, that is, leaving the still image as an afterimage, is called a freeze frame.

In the display still images 41, the background image is removed as a result of the process in step S12. In the display still images 41 on display, the image 42 resembling a skeleton is superimposed on the image of the pedestrian P1 as a result of the process in step S14. The display unit 33 displays the display still image 41 showing the pedestrian P1 remaining after the removal and the image 42 resembling a skeleton. By viewing the display unit 33, a determining person may determine the walking phase by selecting one display still image 41 that is considered to correspond to the walking phase to be determined from among the plurality of display still images 41 on display.

In step S17, the control unit 35 reads the walking phase to be determined input through the input operation on the input unit 34 shown in FIG. 2.

In step S18, detection values detected by the four types of pressure sensors 27 for each of the left and right feet 10 and stored in the storage unit 32 are read. Based on the read detection values, a pressure waveform that shows the change in the detection value over time is created.

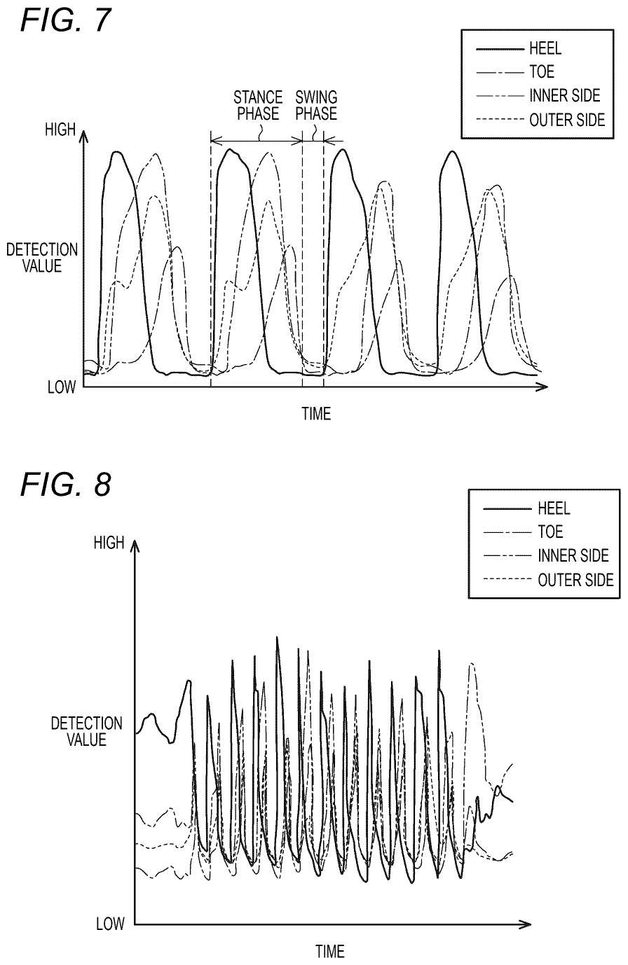

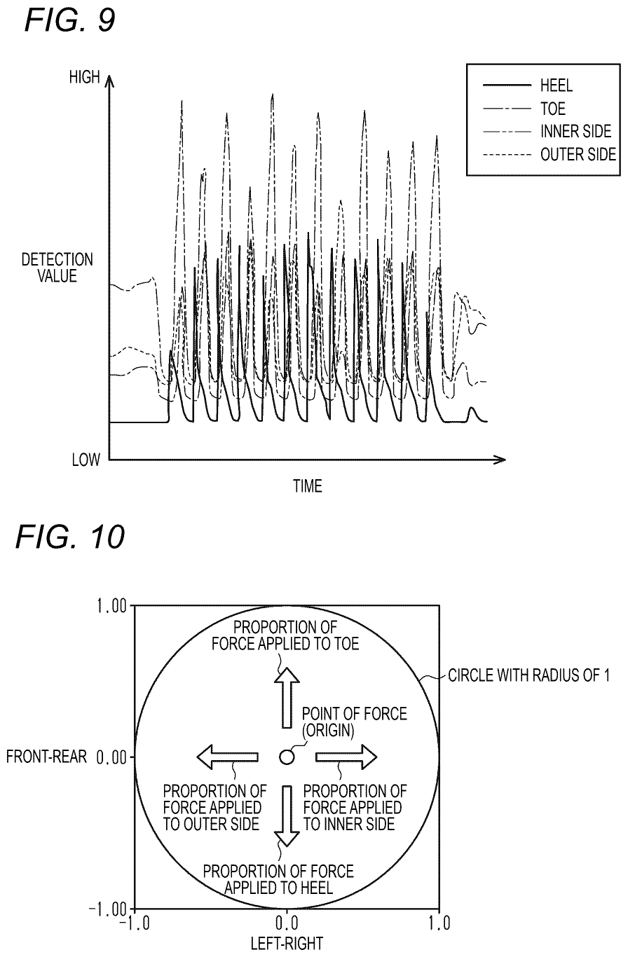

FIG. 7 shows an example of the pressure waveform created by the control unit 35. In FIG. 7, the solid line indicates a pressure waveform created based on detection values of the heel sensor 27a, and the one-dot chain line indicates a pressure waveform created based on detection values of the toe sensor 27b. The two-dot chain line indicates a pressure waveform created based on detection values of the inner sensor 27c, and the broken line indicates a pressure waveform created based on detection values of the outer sensor 27d. FIGS. 8 and 9 show examples of actual pressure waveforms.

FIG. 8 shows a pressure waveform created for the left foot of a particular pedestrian P1. FIG. 9 shows a pressure waveform created for the right foot of the same pedestrian P1 as in FIG. 8.

Here, the pressure waveform is closely related to the walking phase. As shown in FIG. 7, the pressure waveform is a waveform in which a section where the value is substantially constant and a section where the value changes are periodically repeated. The former section is a section in which the foot 10 is away from the walking path 15 (swing phase), and the latter section is a section in which the foot 10 is in contact with the walking path 15 (stance phase). For example, the force applied to the heel 10a increases as the heel 10a touches the ground. This force changes as the ground contact portion of the sole of the foot 10 moves from the heel 10a toward the toe 10b. The force is at a minimum when the heel 10a leaves or is away from the walking path 15. The force applied to the toe 10b also changes in the same manner. Therefore, it is possible to estimate the timing and the walking phase from the pressure waveform.

Therefore, in step S19, the timing when the walking phase of the pedestrian P1 becomes the walking phase to be determined which is designated by the operation on the input unit 34 is estimated as a specific timing from the pressure waveform.

In step S20, features related to the walking motion of the pedestrian P1 is estimated based on the detection values stored in the storage unit 32.

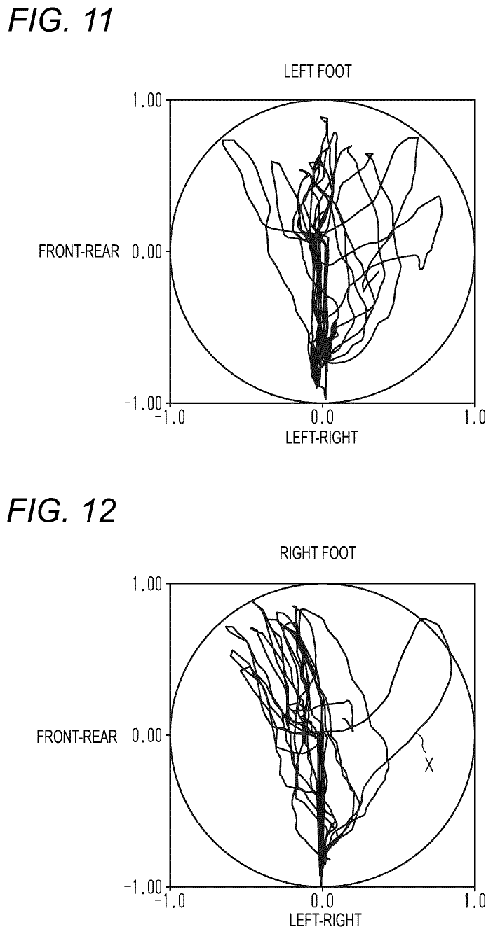

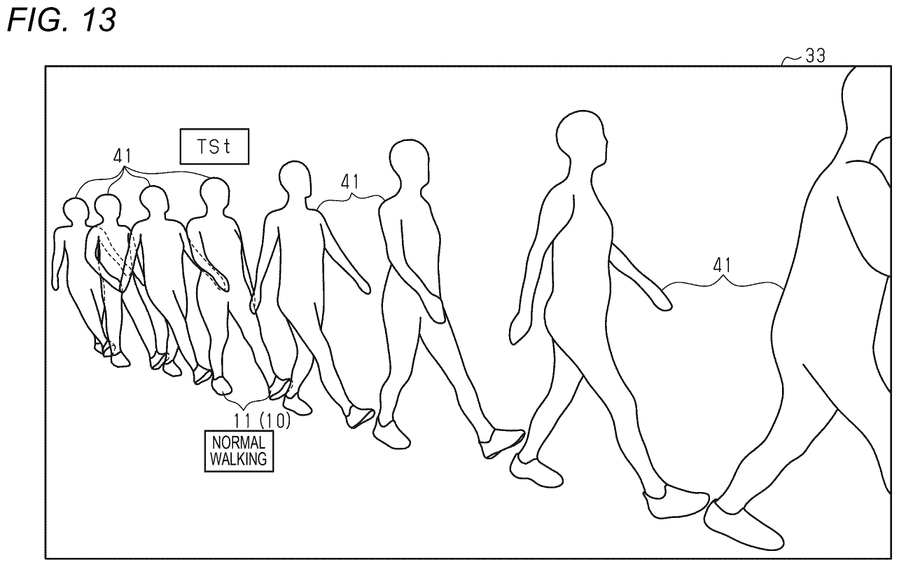

FIGS. 11 and 12 show lines of force that are one of the features related to the walking motion. FIG. 11 shows lines of force estimated for the left foot of the same pedestrian P1 as the pedestrian P1 for which the pressure waveforms in FIGS. 8 and 9 are created. FIG. 12 shows lines of force estimated for the right foot of the same pedestrian P1 as in FIG. 11.

As shown in FIG. 10, a circle with a radius of 1 is assumed to express the lines of force. This circle corresponds to the sole of the foot. The center of the circle marks the origin. A direction in which a vertical axis extends indicates a front-rear direction among directions in which the force of the foot 10 is applied to the insole 26. A direction in which a horizontal axis extends indicates a left-right direction among directions in which the force of the foot 10 is applied to the insole 26.

The heel sensor 27a is located within the circle and behind the origin. The toe sensor 27b is located within the circle and in front of the origin. The inner sensor 27c and the outer sensor 27d are located within the circle at positions sandwiching the origin from both left and right sides.

When a force is applied to the insole 26, the force is applied to each pressure sensor 27. The center where the force is applied to the four pressure sensors 27 is referred to as a “point of force”. When the forces acting on the four pressure sensors 27 are balanced, the point of force is located at the origin.

When the forces acting on the four pressure sensors 27 are not balanced, the point of force is located at a point away from the origin. The balance of forces is expressed by a proportion of the detection values of the four pressure sensors 27. For example, as the proportion of the force applied to the toe sensor 27b increases, the point of force moves forward from the origin to a point away by an amount corresponding to the proportion.

Therefore, the proportion of the detection values of the four pressure sensors 27 is obtained. The point of force is moved by the obtained proportion toward a side where the pressure sensor 27 having a higher proportion is disposed.

Specifically, the point of force is moved forward by the proportion of the force applied to the toe sensor 27b. The point of force is moved rearward by the proportion of the force applied to the heel sensor 27a. When the point of force is on the left foot, the point of force is shifted to the right by the proportion of the pressure applied to the inner sensor 27c. The point of force is shifted to the left by the proportion of the pressure applied to the outer sensor 27d.

The relationship between the inner side and the outer side of the right foot and the left foot is opposite in the left-right direction.

The lines of force shown in FIGS. 11 and 12 are obtained by estimating a trajectory of the points of force that moves over time. In step S20, the lines of force are estimated as described above.

In step S21, based on the lines of force estimated in step S20, it is determined whether the walking motion at the specific timing is abnormal, that is, whether there is an abnormality in the walking motion. For example, a region of lines of force that may be taken by a normal pedestrian P1 is determined in advance, and it is determined whether the lines of force estimated in step S20 are within the region. When the lines of force are within the region, it is determined that there is no abnormality in the walking motion, that is, the walking is normal, and when a line of force is out of the region, it is determined that there is abnormality in the walking motion, that is, the walking is abnormal. For example, as shown in FIG. 12, most of the lines of force estimated for the right foot change in the front-rear direction in a predetermined region in the left-right direction. However, a portion of a line of force indicated by the reference sign X changes so as to greatly protrude obliquely forward from the region. In this case, it may be determined that there is an abnormality in the walking motion.

In step S22, among the plurality of display still images 41, the display still image 41 corresponding to the specific timing estimated in step S19 is displayed on the display unit 33 in a form associated with the walking phase to be determined. The display still image 41 shows the image of the pedestrian P1 remaining after the background image removal and the image 42 resembling the skeleton. For example, as shown in FIG. 1, in the display still image 41 corresponding to the specific timing, characters representing the walking phase to be determined are displayed on or near the image of the pedestrian P1. When the walking phase to be determined read in step S17 is the terminal stance phase TSt, characters “TSt” are displayed above the image of the pedestrian P1 in the corresponding display still image 41. At this time, the image of the pedestrian P1 may be highlighted in a different form from the other display still images 41. For example, the image of the pedestrian PI may be displayed in a color different from that of the images of the pedestrian P1 in the other display still images 41. The image of the pedestrian P1 may also be displayed in a blinking manner.

In addition, in step S22, the display still image 41 corresponding to the specific timing is displayed on the display unit 33 in a manner associated with a determination result in step S21, that is, the presence or absence of an abnormality. For example, as shown in FIG. 1, in the display still image 41 corresponding to the specific timing, characters representing the determination result are displayed on or near the image of the pedestrian P1. For example, characters “abnormal walking” or “normal walking” are displayed.

As described above, among the plurality of display still images 41 displayed on the display unit 33, the display still image 41 corresponding to the specific timing is displayed in a form different from the other display still images 41.

Therefore, by viewing the display unit 33, a determining person may determine which display still image 41 among the plurality of display still images 41 on display corresponds to the designated walking phase to be determined. In addition, by comparing the display still image 41 corresponding to the walking phase to be determined with the display still image 41 determined (selected) by the determining person, it is possible to determine whether the determination of the determining person for the walking phase is correct. In addition, it is also possible to determine the presence or absence of an abnormality related to the walking motion. Further, a state of the skeleton may also be known by viewing the image 42 superimposed on the image of the pedestrian P1 and resembling the skeleton.

### Effects of Present Embodiment

(1) In the present embodiment, the moving image captured by the imaging unit 20 is displayed on the display unit 33 (step S15). In addition, among the still images included in the moving image, a plurality of still images captured at a plurality of different timings are displayed on the display unit 33 as the display still images 41 (step S16).

Therefore, the determining person may subjectively determine the walking phase by selecting the display still image 41 that is considered to correspond to the walking phase to be determined from among the plurality of display still images 41 being displayed on the display unit 33.

In the present embodiment, the specific timing when the walking phase of the pedestrian P1 becomes the walking phase to be determined which is designated by the operation on the input unit 34 is estimated based on the change over time in the detection value of the detection unit 25 (step S19). Among the plurality of display still images 41, the display still image 41 corresponding to the specific timing is displayed on the display unit 33 in a form associated with the walking phase to be determined (step S22).

Therefore, the determining person may know that the display still image 41 being displayed on the display unit 33 corresponds to the walking phase to be determined which is designated by itself. In addition, the determining person may know whether or not the result determined (selected) by itself is correct. If the result is not correct, the cause is considered and used for the determination of the next walking phase, so that the accuracy of the determination may be improved.

As described above, according to the present embodiment, it is possible to support the determining person to increase the determination accuracy of the walking phase.

In addition, as long as the environment allows the transmission and reception of the imaging data and the detection value of the pressure, the above-described effect may be obtained even in a location away from a location where the walking motion of the pedestrian P1 is imaged and the pressure applied to the sole of the pedestrian P1 is detected, that is, in a remote location.

(2) In the present embodiment, the background image that is not involved in the determination of the walking phase is removed from the still images forming the moving image (step S12), so that the image in which only the pedestrian P1 appears is displayed on the display unit 33 as the display still image 41 (step S16).

Therefore, compared to a case where the display still image 41 including the background is displayed on the display unit 33, the image of the pedestrian P1 is easily observed, and the walking phase is easily determined.

(3) In the present embodiment, the lines of force are estimated as a feature related to the walking motion of the pedestrian P1 based on the detection value of the detection unit 25 (step S20). Based on the lines of force, it is determined whether the walking motion at the specific timing is abnormal walking (step S21). The display still image 41 corresponding to the specific timing is displayed on the display unit 33 in a form associated with the determination result (step S22).

Therefore, the determining person may know whether the walking at the specific timing is abnormal walking by viewing the display unit 33.

(4) In the present embodiment, data of the skeleton of the pedestrian P1 is estimated based on each still image (step S13). Each still image includes the display still image 41 corresponding to the specific timing. The image 42 corresponding to the data of the skeleton and resembling the skeleton is displayed on the display unit 33 in a state of being superimposed on the image of the pedestrian P1 in each still image (step S16).

Therefore, by viewing the display unit 33, the determining person may determine the state of the skeleton of the pedestrian P1 when the walking phase is at least the walking phase to be determined, for example, a degree of a joint angle. In this case, for example, the joint angle can be evaluated by measuring the joint angle.

### Modifications

The present embodiment can be modified and implemented as follows. The present embodiment and the following modifications may be combined with each other and implemented without technical contradiction.
At least one of the number and the arrangement positions of the imaging devices 21 may be changed. For example, in a case where two imaging devices 21 are provided in the imaging unit 20, the imaging devices 21 may be arranged at two locations sandwiching the end portion 15a and the end portion 15b of the walking path 15 and near the end portions 15a and 15b in a state of facing each other. When the pedestrian P1 walks along the walking path 15 from the end portion 15b toward the end portion 15a, the imaging device 21 disposed near the end portion 15a images the pedestrian P1 from the front as the pedestrian P1 approaches while walking. The imaging device 21 disposed near the end portion 15b images the pedestrian P1 from behind as the pedestrian P1 walks away.

Only one of the imaging device 21 that images the pedestrian P1 from the front and the imaging device 21 that images the pedestrian P1 from behind may be used.

In addition to or instead of at least one of the two imaging devices 21, another imaging device 21 may be disposed between the end portions 15a and 15b at a location away from the walking path 15 in a width direction of the walking path 15. The imaging device 21 images the pedestrian P1 walking along the walking path 15 from the side.
The number and arrangement of the pressure sensors 27 incorporated in the insole 26 may be changed as appropriate.
In the above embodiment and the above modifications, pressure is described as one type of force, and the force may also be acceleration or torque. The force sensor may be an acceleration sensor, a torque sensor, or the like that detects these forces. These sensors may be incorporated in the insole 26, for example.
The imaging unit 20 may include a storage unit that stores imaging data captured by the imaging device 21. The detection unit 25 may include a storage unit that stores a detection value of the pressure sensor 27.

When a removable recording medium such as a memory card is used as the storage unit in the imaging unit 20, the transmission unit 22 may be omitted. When a recording medium similar to that described above is used as the storage unit in the detection unit 25, the transmission unit 28 may be omitted. When both of the transmission units 22 and 28 are omitted, the reception unit 31 of the determination support device 30 may be omitted.
The process of step S14 in the flowchart of FIG. 6, that is, the process of superimposing the image 42 resembling the skeleton on the image of the pedestrian P1 may be omitted. In this case, by performing the processes of step S16 and step S22, as shown in FIG. 13, only the display still image 41 of the pedestrian P1 is displayed on the display unit 33 without the image 42 resembling the skeleton being superimposed thereon.
In the flowchart of FIG. 6, the processes of steps S17 to S22 may be omitted. In this case, the moving image captured by the imaging unit 20 is displayed on the display unit 33. In addition, the display unit 33 displays the display still images 41, which are a plurality of still images captured at different timings, in which the image 42 resembling the skeleton is superimposed on the image of the pedestrian P1.

Therefore, the determining person may accurately determine the walking phase by observing the image of the pedestrian P1 and the image 42 resembling the skeleton in the display still image 41. Therefore, in this modification, an effect of supporting the determination of the walking phase performed by viewing the walking motion of the pedestrian P1 may also be obtained.
The process of displaying the image 42 corresponding to the skeleton data and resembling the skeleton on the display unit 33 in a state of being superimposed on the image of the pedestrian P1 in each still image may be performed only on the display still image 41 corresponding to the specific timing.
One or more walking phases to be determined may be input through the operation on the input unit 34. In this case, the specific timings are estimated in a number corresponding to the input walking phases to be determined. Then, among the plurality of display still images 41, the display still image 41 corresponding to each specific timing is displayed on the display unit 33 in a form associated with the walking phase to be determined.

### Supplementary Notes

Technical ideas that may be grasped from the above embodiment and modifications will be described.

(A) A walking phase determination support system that supports determination of a walking phase performed by observing a walking motion of a pedestrian, the walking phase determination support system including:
an imaging unit configured to image the walking motion of the pedestrian;
a detection unit configured to detect a change over time in a force applied to each of a plurality of parts of a sole of the pedestrian in synchronization with imaging by the imaging unit;
an input unit configured to be operated to designate a walking phase to be determined that is a target of the determination among a walking cycle including a plurality of types of the walking phase;
a display unit configured to display a video related to the walking motion of the pedestrian; and
a control unit configured to display, on the display unit, a moving image captured by the imaging unit, and display, on the display unit as display still images, a plurality of still images captured at a plurality of different timings from among still images forming the moving image, in which
the control unit is configured to estimate data of a skeleton of the pedestrian based on at least the display still image corresponding to the specific timing, and display an image corresponding to the data of the skeleton and resembling the skeleton on the display unit in a state of being superimposed on an image of the pedestrian in the display still image.

According to the above configuration, a determining person can accurately determine the walking phase by observing the image of the pedestrian and the image resembling the skeleton in the display still image. In this case, the determination accuracy can also be improved by supporting the determination of the walking phase by the determining person.

What is claimed is:

1. A walking phase determination support system that supports determination of a walking phase performed by observing a walking motion of a pedestrian, the walking phase determination support system comprising:
an imaging unit configured to image the walking motion of the pedestrian;
a detection unit configured to detect a change over time in a force applied to each of a plurality of parts of a sole of the pedestrian in synchronization with imaging by the imaging unit;
an input unit configured to be operated to designate a walking phase to be determined that is a target of the determination among a walking cycle including a plurality of types of the walking phase;
a display unit configured to display a video related to the walking motion of the pedestrian; and
a control unit configured to display, on the display unit, a moving image captured by the imaging unit, and display, on the display unit as display still images, a plurality of still images captured at a plurality of different timings from among still images forming the moving image,
wherein the control unit is configured to estimate, based on a change over time in a detection value of the detection unit, as a specific timing, a timing at which the walking phase of the pedestrian becomes the walking phase to be determined that is designated by an operation on the input unit, and is configured to display, on the display unit, one display still image corresponding to the specific timing among the plurality of display still images in a form associated with the walking phase to be determined.

2. The walking phase determination support system according to claim 1,
wherein the control unit is configured to remove a background image from the still images and display, on the display unit as the display still images, the still images after the background image is removed.

3. The walking phase determination support system according to claim 1,
wherein the control unit is configured to estimate a feature related to the walking motion of the pedestrian based on a detection value of the detection unit, determine whether the walking motion at the specific timing is abnormal walking based on the feature, and display the display still image corresponding to the specific timing on the display unit in a form associated with a result of the determination related to the abnormal walking.

4. The walking phase determination support system according to claim 1,
wherein the control unit is configured to estimate data of a skeleton of the pedestrian based on at least the display still image corresponding to the specific timing, and display an image corresponding to the data of the skeleton and resembling the skeleton on the display unit in a state of being superimposed on an image of the pedestrian in the display still image corresponding to the specific timing.
